(19) United States
(12) Patent Application Publication
(10) Pub. No.: US 2014/0344396 A1
(43) Pub. Date: Nov. 20, 2014

(54) TRANSMISSION MANAGEMENT DEVICE, SYSTEM, AND METHOD

(71) Applicant: POWER-ALL NETWORKS LIMITED, Shatin (HK)

(72) Inventor: STEVE LAP WAI HUI, Shatin (HK)

(73) Assignee: POWER-ALL NETWORKS LIMITED, Shatin (HK)

(21) Appl. No.: 14/278,670

(22) Filed: May 15, 2014

(30) Foreign Application Priority Data
May 16, 2013 (CN) 2013101815876

(51) Int. Cl. H04L 12/721

(52) U.S. Cl. CPC H04L 45/14
USPC 709/217

(57) ABSTRACT

A transmission management method includes receiving a sending request from one electronic device when the one electronic device sends data to another electronic device. Determining which areas the electronic device sending the data and the electronic device receiving the data are located. Obtaining at least one transmission path between the two determined areas where the electronic device sending the data and the electronic device receiving the data are located. Selecting a optimal transmission path from the determined at least one transmission path according to workloads of the routers of each transmission path. In addition, controlling the electronic device sending the data and the electronic device receiving the data to communicate with each other via the determined optimal transmission path.

### CROSS REFERENCE TO RELATED APPLICATIONS

This application is related to the following co-pending, commonly assigned patent applications, the disclosures of which are incorporated herein by reference in their entirety:

1. “TRANSMISSION MANAGEMENT DEVICE, SYSTEM, AND METHOD” by Steve Lap Wai Hui, whose Attorney Docket No is US51795.

2. “TRANSMISSION MANAGEMENT DEVICE, SYSTEM, AND METHOD” by Steve Lap Wai Hui, whose Attorney Docket No is US51797.

3. “TRANSMISSION MANAGEMENT DEVICE, SYSTEM, AND METHOD” by Steve Lap Wai Hui, whose Attorney Docket No is US51798.

### FIELD

The present disclosure relates to device, and particularly to a transmission management device, a system, and a method thereof.

### BACKGROUND

Electronic devices, such as mobile phones and tablet computers, are popular. Usually, the electronic devices can communicate with each other and access networks via corresponding networks. However, in some situations, when electronic devices connect to networks according to a certain network bandwidth assigned by a corresponding network operator, and when the number of people accessing the network is great, the resulting access speed can be very slow.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of a transmission management device.

FIG. 2 is a schematic diagram of an embodiment of a transmission path.

FIG. 3 is a flowchart diagram of an embodiment of a transmission management method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

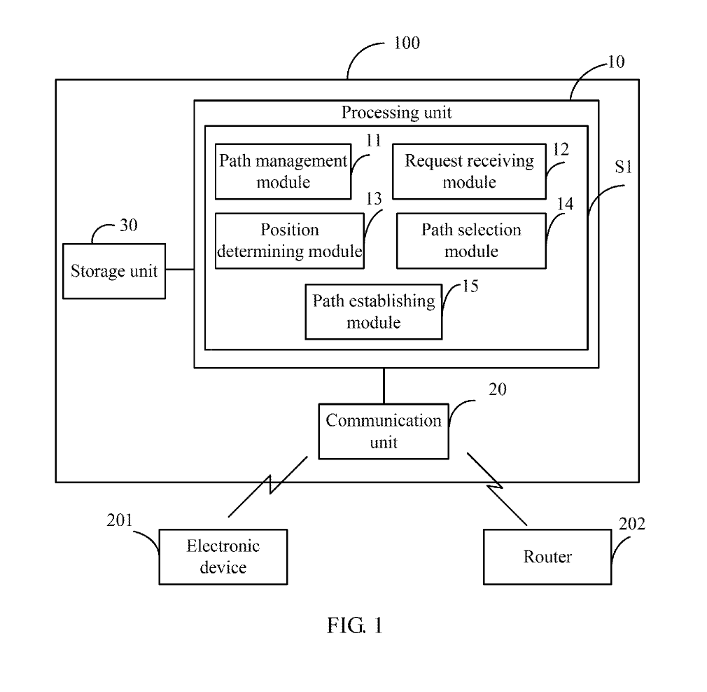

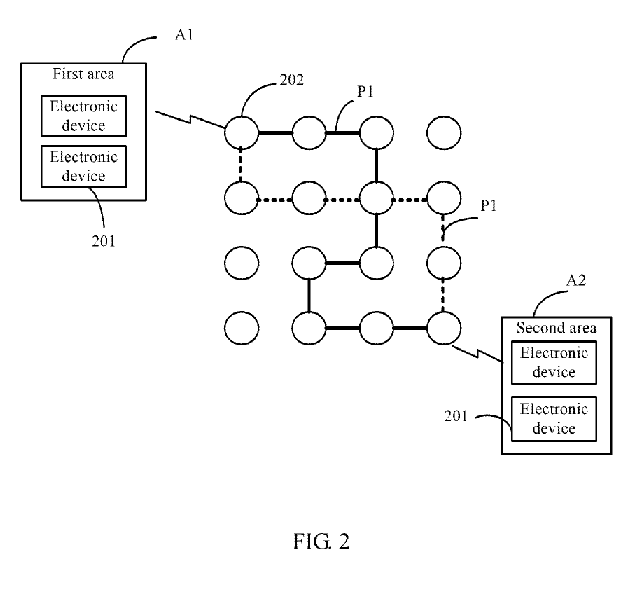

FIGS. 1-2 illustrate a transmission management device 100 of the embodiment. The transmission management device 100 includes a processing unit 10, a communication unit 20, and a storage unit 30.

The transmission management device 100 couples a number of electronic devices 201 and a number of routers 202 via the communication unit 20. The routers 202 respectively belong to different network operators or all belong to the same network operator. The communication unit 20 connects the transmission management device 100 with the electronic devices 201 and the routers 202 via corresponding networks, such as, internet, a wireless network including WIFI and BLUETOOTH, a telecommunication network including a GPRS network and a CDMA network, or a broadcasting network, for example.

The storage unit 30 stores location information of each router 202 and each electronic device 201. The location information of each router 202 includes a geographic location and an Internet protocol (IP) address of the router 202, the location information of each electronic device 201 also includes a geographic location and an IP address of the electronic device 201.

In the embodiment, the storage unit 30 further stores a transmission management system 51. The transmission management system 100 includes a number of modules, which are a collection of software instructions and are executed by the processing unit 10 of the transmission management device 100. The modules include a path management module 11, a request receiving module 12, a position determining module 13, a path selection module 14, and a path establishing module 15. In the embodiment, the storage unit 30 can be a hard disk, a compact disk, or a flash memory, for example. The processing unit 10 can be a central processing unit, a digital processor, a single chip, for example.

The path management module 11 is used to determine at least two areas according to the location information of the electronic devices 201, and determine at least one transmission path P1 between each two areas. In the embodiment, each area includes at least one electronic device 201, the area can be a city that the at least one electronic device 201 is located. In detail, as illustrated in FIG. 2, the path management module 11 determines a first area A1 and a second area A2, and determines at least one router 202 located between the first area A1 and the second area A2 according to the location information of the routers 202 stored in the storage unit 30. The path management module 11 then determines at least one transmission path P1 according to the at least one router 202 located between the first area A1 and the second area A2. In the embodiment, the first area A1 and the second area A2 can be different cities, such as, the first area A1 can be Los Angeles, and the second area A2 can be New York.

For example, when the path management module 11 determines the first area A1 is Los Angeles, and determines the second area A2 is New York, the path management module 11 determines the routers 202 located between Los Angeles and New York, according to the location information of the routers 202 stored in the storage unit 30. The path management module 11 then determines at least one transmission path each constituted by some of the routers 202 located between Los Angeles and New York connected to each other one by one.

Obviously, the areas that the path management module 11 determined according to the location information of the electronic devices 201 further include other cities, such as, Washington, or Chicago, for example. In another embodiment, the areas, such as, the first area A1 and the second area A2 also can be different areas of the same city.

In the embodiment, when any one router 202 is installed, the path management module 11 updates the location information of the routers 202 stored in the storage unit 30, and then determines the transmission path between each two areas according to the updated location information of the routers 202.

The request receiving module 12 is used to receive a sending request from one electronic device 201 when the one electronic device 201 sends data to another electronic device 201.

The position determining module 13 is used to determine which areas the two electronic devices 201 are located, namely which areas the electronic device 201 sending the data and the electronic device 201 receiving the data are located. In the embodiment, the sending request includes location information of both of the electronic devices 201, and the location information of the first electronic device 201 and the second electronic device 202 respectively include geographic location and an internet protocol (IP) address of the two electronic devices 201. The position determining module 13 determines the geographic locations of the two electronic devices 201 according to the location information included in the sending request, and then determines which areas the two electronic devices 201 are located according to the geographic locations of the two electronic devices 201.

In another embodiment, the location information of the two electronic devices 201 only includes the IP addresses of the two electronic devices 201. The position determining module 13 locates the geographic locations of the two electronic devices 201 according to the IP addresses of the two electronic devices 201, based on the global position system. The position determining module 13 then determines which areas the two electronic devices 201 are located according to the geographic locations of the two electronic devices 201.

The path selection module 14 is used to obtain at least one transmission path between the two determined areas where the electronic device 201 sending the data and the electronic device 201 receiving the data are located. In addition, a optimal transmission path is selected from the determined at least one transmission path according to the workloads of the routers 202 of each transmission path P1. In the embodiment, the path selection module 14 obtains the at least one transmission path between the two determined areas according to the transmission path of each two areas determined by the path management module 11 and where the two determined areas are.

In the embodiment, the path selection module 14 determines the routers 202 with workload less than a predetermined workload of each transmission path between the two determined areas. The path selection module 14 then calculates a percent of the routers 202 with workload less than the predetermined workload of each transmission path, and then determines a transmission path has a maximum percent of routers 202 with workload less than the predetermined workload as the optimal transmission path. In the embodiment, the workload of the router 202 includes network utilization ratio of the router 202. The network utilization ratio is the ratio of current network traffic to the maximum network traffic that the router 202 can handle. When more data is transmitted/received and processed by one router 202, the network utilization ratio is greater, and the workload of the router 202 is heavy. In the embodiment, the path selection module 14 determines the workload of the router 202 is less than the predetermined workload by determining the network utilization ratio is less than the predetermined workload. In the embodiment, the predetermined workload is 50%.

The path establishing module 15 controls the first electronic device 201 and the second electronic device 202 to communicate with each other via the optimal transmission path according to the optimal transmission path determined by the path selection module 14.

Thus, because the optimal transmission path is constituted by most of routers 202 with workloads less than the predetermined workload, then the transmission speed between the two electronic devices 201 is enhanced.

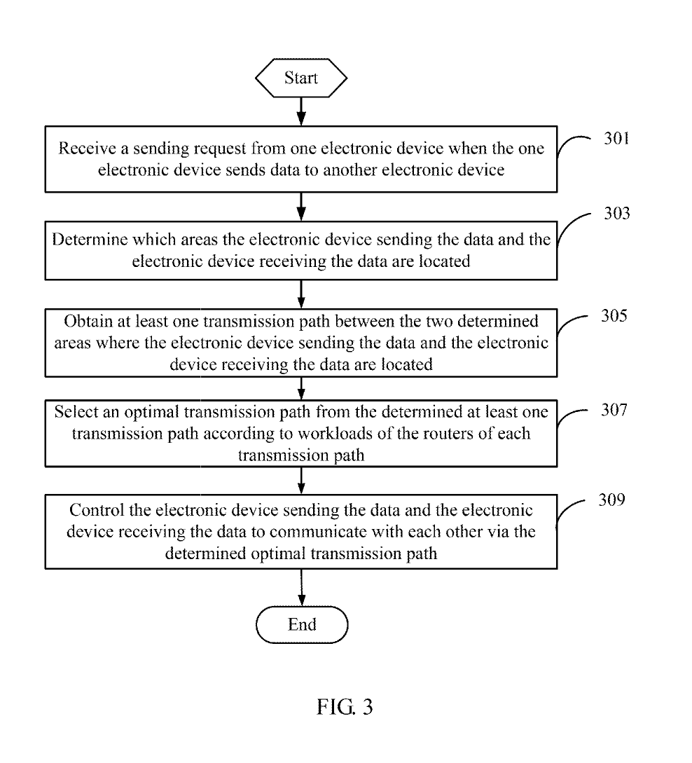

FIG. 3 illustrates a flowchart of a transmission management method. In 304, the request receiving module 12 receives a sending request from one electronic device 201 when the one electronic device 201 sends data to another electronic device 201.

In 303, the position determining module 13 determines which areas the two electronic devices 201, namely the electronic device 201 sending the data and the electronic device 201 receiving the data are located. In the embodiment, the sending request includes location information of both of the two electronic devices 201, and the location information of the two electronic devices 201 respectively include geographic location and an internet protocol (IP) address of the two electronic devices 201. The position determining module 13 determines the geographic locations of the two electronic devices 201 according to the location information included in the sending request, and then determines which areas the two electronic devices 201 are located according to the geographic locations of the two electronic devices 201. In another embodiment, the location information of the two electronic devices 201 includes only the internet protocol (IP) address of the two electronic devices 201. The position determining module 13 locates the geographic locations of the two electronic devices 201 according to the IP addresses of the two electronic devices 201, based on the global position system. The position determining module 13 then determines which areas the two electronic devices 201 are located according to the geographic locations of the two electronic devices 201.

In 305, the path selection module 14 obtains at least one transmission path between the two determined areas where the electronic device 201 sending the data and the electronic device 201 receiving the data are located. In detail, the path management module 11 determines at least two areas according to the location information of the electronic devices 201, and determines at least one transmission path P1 between each two areas. The path selection module 14 obtains the at least one transmission path between the two determined areas according to the transmission path of each two areas determined by the path management module 11 and where the two determined areas are.

In 307, the path selection module 14 then selects a optimal transmission path from the determined at least one transmission path according to workloads of the routers 202 of each transmission path P1. In detail, the path selection module 14 determines the routers 202 with workloads less than a predetermined workload, of each transmission path between the two determine areas, and calculates a percent of the routers 202 with workloads less than the predetermined workload of each transmission path, and then determines a transmission path has the maximum percent of the routers 203 with workloads less than the predetermined workload as the optimal transmission path.

In 309, the path establishing module 15 controls the two electronic devices 201 to communicate with each other via the optimal transmission path determined by the path selection module 14.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A transmission management system, applied to a transmission management device comprising a storage unit and a communication unit for connecting to a plurality of electronic devices and routers, the system comprising:
a processing unit;
a plurality of modules which are collection of instructions executed by the processing unit, the plurality of modules comprising:
a path management module configured to determine at least two areas according to location information of the electronic devices stored in the storage unit, and to determine at least one transmission path between each two areas;
a request receiving module configured to receive a sending request from one electronic device when the one electronic device sends data to another electronic device;
a position determining module configured to determine which areas the electronic device sending the data and the electronic device receiving the data are located;
a path selection module configured to obtain at least one transmission path between the two determined areas where the electronic device sending the data and the electronic device receiving the data are located, and select a optimal transmission path from the determined at least one transmission path according to workloads of the routers of each transmission path; and
a path establishing module configured to control the two electronic devices to communicate with each other via the optimal transmission path determined by the path selection module.

2. The system according to claim 1, wherein the path management module determines at least one router located between each two areas according to the location information of the routers stored in the storage unit, and then determines at least one transmission path according to the at least one router located between the each two areas.

3. The system according to claim 1, wherein the sending request comprises location information of both of the electronic device sending the data and the electronic receiving the data, and the location information of the two electronic devices respectively comprises a geographic location and an internet protocol (IP) address of the two electronic devices, the position determining module then determines the geographic locations of the two electronic devices according to the location information comprised in the sending request, and then determines which areas the two electronic devices are located according to the geographic locations of the two electronic devices.

4. The system according to claim 1, wherein the location information of the two electronic devices comprises IP addresses of the electronic device sending the data and the electronic receiving the data, the position determining module locates the geographic locations of the two electronic devices according to the IP addresses of the two electronic devices based on the global position system, and then determines which areas the two electronic devices are located according to the geographic locations of the two electronic devices.

5. The system according to claim 1, wherein the path selection module determines the routers with workload less than a predetermined workload of each transmission path between the two determined areas, and calculates a percent of the routers with workload less than the predetermined workload of each transmission path, and then determines a transmission path has the maximum percent of the routers with workload less than the predetermined workload as the optimal transmission path.

6. The system according to claim 5, wherein the workload of each router comprises a network utilization ratio of the router, and the path selection module determines the workload of the router is less than the predetermined workload by determining the network utilization ratio is less than the predetermined workload.

7. A transmission management device, comprising:
a communication unit configured to communicate with a plurality of electronic devices and a plurality of routers;
a storage unit configured to store location information of the plurality of routers and the plurality of electronic devices;
a processing unit configured to execute a plurality of modules which are collection of instructions, the plurality of modules comprising:
a path management module configured to determine at least two areas according to the location information of the electronic devices stored in the storage unit, and determine at least one transmission path between each two areas;
a request receiving module configured to receive a sending request from one electronic device when the one electronic device sends data to another electronic device;
a position determining module configured to determine which areas the electronic device sending the data and the electronic device receiving the data are located;
a path selection module configured to obtain at least one transmission path between the two determined areas where the electronic device sending the data and the electronic device receiving the data are located, and select a optimal transmission path from the determined at least one transmission path according to workloads of the routers of each transmission path; and
a path establishing module configured to control the two electronic devices to communicate with each other via the optimal transmission path determined by the path selection module.

8. The device according to claim 7, wherein the path management module determines at least one router located between each two areas according to the location information of the routers stored in the storage unit, and then determines at least one transmission path according to the at least one router located between the each two areas.

9. The device according to claim 7, wherein the sending request comprises location information of both of the electronic device sending the data and the electronic receiving the data, and the location information of the two electronic devices respectively comprises a geographic location and an internet protocol (IP) address of the two electronic devices, the position determining module then determines the geographic locations of the two electronic devices according to the location information comprised in the sending request, and then determines which areas the two electronic devices are located according to the geographic locations of the two electronic devices.

10. The device according to claim 7, wherein the location information of the two electronic devices comprises IP addresses of the electronic device sending the data and the electronic receiving the data, the position determining module locates the geographic locations of the two electronic devices according to the IP addresses of the two electronic devices based on the global position system, and then determines which areas the two electronic devices are located according to the geographic locations of the two electronic devices.

11. The device according to claim 7, wherein the path selection module determines the routers with workload less than a predetermined workload of each transmission path between the two determined areas, and calculates a percent of the routers with workload less than the predetermined workload of each transmission path, and then determines a transmission path has the maximum percent of the routers with workload less than the predetermined workload as the optimal transmission path.

12. The device according to claim 11, wherein the workload of each router comprises a network utilization ratio of the router, and the path selection module determines the workload of the router is less than the predetermined workload by determining the network utilization ratio is less than the predetermined workload.

13. A transmission management method, applied in a transmission management device comprising a storage unit, the method comprising:
receiving a sending request from one electronic device when the one electronic device sends data to another electronic device;
determining which areas the electronic device sending the data and the electronic device receiving the data are located;
obtaining at least one transmission path between the two determined areas where the electronic device sending the data and the electronic device receiving the data are located;
selecting a optimal transmission path from the determined at least one transmission path according to workloads of the routers of each transmission path; and
controlling the electronic device sending the data and the electronic device receiving the data to communicate with each other via the determined optimal transmission path.

14. The method according to claim 13, further comprising:
separating the electronic devices to at least two areas according to the location information of the electronic devices stored in the storage unit, and
determining at least one transmission path between each two areas.

15. The method according to claim 13, wherein the step of selecting a optimal transmission path from the determined at least one transmission path according to workloads of the routers of each transmission path comprises:
determining the routers with workload less than a predetermined workload of each transmission path between the two determined areas;
calculating a percent of the routers with workload less than the predetermined workload of each transmission path; and
determining a transmission path has the maximum percent of the routers with workload less than the predetermined workload as the optimal transmission path.
